(19) United States
(12) Patent Application Publication
(10) Pub. No.: US 2006/0014011 A1
(43) Pub. Date: Jan. 19, 2006

(54) Mutlilayer structure with controlled permeability

(76) Inventors: Bruno Flaconneche, Cormeilles-en-Vexin (FR); Emmanuel Vinciguerra, Nanterre (FR); Marie-Helene Klopffer, Paris (FR); Serge Gonzalez, Decines (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/517,628

(22) PCT Filed: Jun. 3, 2003
(86) PCT No.: PCT/FR03/01670

§ 371 Date: Aug. 9, 2005

(30) Foreign Application Priority Data
Jun. 13, 2002 (FR) 02/07247

(51) Int. Cl. B32B 5/16

(52) U.S. Cl. 428/323; 428/325

(57) ABSTRACT

The present invention relates to a multilayer structure with controlled permeability to hydrocarbons, comprising at least one inner polymer layer (6) and at least one outer layer (5) comprising a mixture of polymer material and of fillers. The fillers are mineral and selected to adsorb and to trap an amount of hydrocarbons released through said inner layer so as to reduce the permeability of the structure. Application to the manufacture of fuel tanks or lines.

### FIELD OF THE INVENTION

The present invention relates to a multilayer structure at least one layer of which consists of a mixture of polymer material and of one or more mineral fillers specifically selected to improve sealing of the polymer material against hydrocarbons by trapping, by adsorption on the fillers, within the polymer material, the hydrocarbons that pass through the polymer by permeability.

The invention notably applies to all the hydrocarbon storage or transportation structures, in particular the fuel tanks, gasoline or diesel oil, and lines in motor vehicles.

### BACKGROUND OF THE INVENTION

Hydrocarbon storage and transportation poses problems linked with the permeability of the thermoplastic polymers used to manufacture the storage and transportation structures. In the particular case of the gasoline tanks of motor vehicles, the amount of hydrocarbon fumes released into the environment because of the permeability of the tank walls is subject to already strict standards that are going to be increasingly severe. The harshest current standards are the American standards (CARB and EPA) which recommend an 0.5 g/25 h emission per vehicle, knowing that each manufacturer then attributes 25% to 35% of these 0.5 g to the permeability of the fuel tank, i.e. 100 to 200 mg/25 h. Furthermore, the new ZEV standard (Zero Ermission Vehicle) will bring the hydrocarbon emission level of the vehicle down to 0.35 g/25 h with a nearly zero contribution (i.e. about 45 to 55 mg/25 h) of the fuel system, and notably with an extremely low emission level guarantee throughout the life of the vehicle.

The following documents describe polymer tanks:
U.S. Pat. No. 5,928,745, which describes a two-layer polymer gasoline tank whose second layer contains a disperse cyclodextrine and/or substituent phase,
EP-1,108,598 and EP-1,108,599, which describe multilayer tanks at least one layer of which consists of a nanocomposite material.

### SUMMARY OF THE INVENTION

The present invention thus relates to a multilayer structure having controlled hydrocarbon permeability, comprising at least one inner polymer layer and at least one outer layer comprising a mixture of polymer material and of fillers. The fillers are mineral and selected to adsorb and trap an amount of hydrocarbons discharged through said inner layer so as to reduce the permeability of the structure.

The adsorbent mineral fillers can be selected from the following group: zeolite, activated charcoal, carbon nanotubes and mixtures thereof.

The polymer of the inner and outer layers can be selected from among: polyolefins (PE, PP), polyamides, fluoropolymers, polymer alloys (PE-PA), elastomers.

The polymer material of the inner layer can comprise permeability-reducing fillers of micrometric type such as talc, metal particles, for example, or of nanometric type such as clays.

Another layer can be inserted between the inner layer and the outer layer.

At least one face can be treated, for example by fluorination, to reduce the permeability.

The structure can be made by extrusion, injection, blowing, rotational moulding or compression.

The invention can be applied to the manufacture of tanks for motor vehicles.

The invention can also be applied to the manufacture of fuel lines for motor vehicles.

The present invention relates to a multilayer structure comprising in combination at least two layers: a layer of reduced permeability by means of a function of adsorption trapping, on specific fillers, of all or part of the hydrocarbons released through this single layer, and a layer whose direct function is to be of reduced permeability.

The present invention is thus based on the combination of two functions for decreasing the discharge of hydrocarbons through the structure. The first function is the use of a sealing barrier material, for example EVOH, PBT, whose permeability can be reduced by addition of fillers. The second function, arranged downstream in relation to the direction of emission of the hydrocarbons through the structure, is based on adsorption trapping of the hydrocarbons on mineral fillers, for example zeolites, activated charcoal, carbon nanotubes. These fillers, known for their adsorption capacity, are already used in the pure state in canisters, but not in combination with a polymer matrix so as to obtain the advantages of the present invention. According to the invention, the amount of filler to be added to the polymer is calculated from knowledge of the permeability of the polymer alone and of the amount of hydrocarbons potentially released during the life of the vehicle through the polymer, through the upstream barrier layer(s).

The polymer materials used have to be compatible with the implementation methods used for manufacture of the type of structures considered (hydrocarbon storage tanks, or lines) and can therefore be polyolefins (polyethylene, polypropylene), polyamides (11, 12, 6, 6-6, 6-10, . . . ), fluoropolymers (PVDF, . . . ), thermoplastic polymers, elastomers, or thermosetting resins.

In order to improve the composition performance, and thus to decrease the amount of adsorbent filler to be added, micrometric or nanometric particle fillers can be used so as to reduce the permeability of the polymer, or the single layer according to the invention can be subjected to a surface treatment (fluorination of the polyolefins for example).

### BRIEF DESCRIPTION OF THE FIGURES

Other features and advantages of the invention will be clear from reading the description hereafter, given by way of non limitative example, with reference to the accompanying figures wherein:

FIG. 1 illustrates one of the structures of the prior art,

FIG. 2 diagrammatically shows the principle of the invention, and

FIG. 3 illustrates a variant of the present invention.

### DETAILED DESCRIPTION

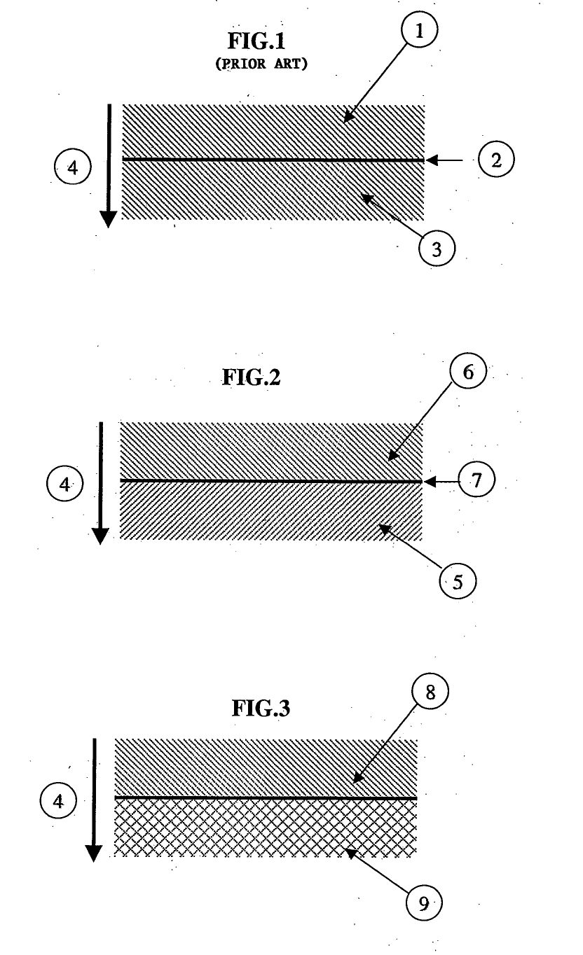

According to FIG. 1, a structure according to the prior art consists of a first polymer layer 1, for example HDPE, of a sealing barrier polymer layer 2 made of EVOH or PA, then of an outer polymer layer 3 made of HDPE comprising varying amounts of recycled HDPE. Arrow 4 shows the direction of emission of the hydrocarbons, i.e. layer 1 is the inner layer in contact with the hydrocarbons and layer 3 is the outer layer. This type of structure allows to use a highly impermeable polymer as intermediate layer 2 in form of a very thin sheet, which limits the cost thereof.

FIG. 2 illustrates the principle of the invention wherein an outer layer 5 comprises a polymer matrix in which mineral fillers are dispersed. The function of the mineral fillers selected is to adsorb the hydrocarbon molecules that can pass through the polymer matrix. The filler has no significant effect on the permeability value of the matrix, but it acts as a trap for the hydrocarbon molecules, thus preventing them from passing completely through the wall and from dispersing in the atmosphere.

According to the invention, layer 5 covers at least one low-permeability inner layer 6, HDPE for example. This inner layer can be fluorinated, or treated in an equivalent manner in order to limit its permeability. In the embodiment of FIG. 2, another polymer layer 7, of very low permeability, is inserted between inner layer 6 and outer layer 5. This generally thin layer is made of EVOH or PA. The present structure advantageously combines:
an inner layer 6 whose main function is the mechanical resistance of the assembly, while keeping a certain permeability,
an outer layer 5 which traps by adsorption the hydrocarbons released through the inner layer,
to complete permeability control of the inner layer, a barrier layer 7 can be inserted, and/or a fluorination type treatment can be carried out.

FIG. 3 is a variant of the invention wherein the permeability of inner layer 8 is reduced by addition of micrometric or nanometric particles. In a variant, outer layer 9 is also based on a polymer matrix whose permeability is reduced by addition of micrometric or nanometric particles.

The polymer gasoline tank of a motor vehicle is manufactured in most cases by extrusion-blowing, and the amount of material used is about 6 kg in the case of polyethylene.

In the case of multilayer structures, the hydrocarbon emissions measured by means of the SHED test according to the current standards can be estimated below 150 mg/25 h and ranging between 50 and 100 mg/25 hours depending on the type of fuel used.

Fuel absorption measurements performed on polyethylene+adsorbent filler mixtures according to the invention have allowed to obtain collection rates of the order of 15% to 25% for the filler, which corresponds to an adsorption of 150 mg to 250 mg/g filler.

Addition of micrometric or nanometric fillers in the inner layer allows the permeability to be reduced by a factor 2 to 10 maximum.

Considering average values for hydrocarbon emissions from a tank (i.e. about 50 and 100 mg/25 h) and a permeability reduction factor 4 using micrometric or nanometric fillers, the emission through this structure is calculated for 10 years: about 50 to 100 g in 10 years.

Considering a collection rate of about 15% for adsorbent fillers included in the outer layer, 150 g to 300 g adsorbent fillers have to be added to trap all of the fumes released during the 10-year life of the vehicle, which corresponds to filler mass proportions below 10% for such a tank consisting of the structure illustrated in FIG. 3.

This calculation is not optimized and, if one of the data changes (polymer type, emissions decrease, collection improvement, . . . ), the proportions of adsorbent fillers can be greatly reduced.

It is therefore clear that these mass proportions pose no industrial problem for the manufacture of polymer tanks. Thus, the invention and its variants afford a definite advantage for reduction and control of hydrocarbon emissions from a hydrocarbon-containing structure.

1. A controlled hydrocarbon permeability multilayer structure comprising at least one inner polymer layer (6, 8) and at least one outer layer (5, 9) comprising a mixture of polymer material and of fillers, characterized in that said fillers are mineral and selected to adsorb and to trap an amount of hydrocarbons discharged through said inner layer so as to reduce the permeability of said structure.

2. A structure as claimed in claim 1, wherein said adsorbent mineral fillers are selected from the following group: zeolite, activated charcoal, carbon nanotubes and mixtures thereof.

3. A structure as claimed in claim 1, wherein the polymer of the inner and outer layers is selected from polyolefins (PE, PP), polyamides, fluoropolymers, polymer alloys (PE-PA), elastomers.

4. A structure as claimed in claim 1, wherein the polymer material of the inner layer comprises permeability-reducing fillers of micrometric type, such as talc, metal particles for example, or of nanometric type, such as clays for example.

5. A structure as claimed in claim 1, wherein another layer (7) is inserted between the inner layer and the outer layer.

6. A structure as claimed in claim 1, wherein at least one face is treated, for example by fluorination, to reduce the permeability.

7. A structure as claimed in claim 1, made by extrusion, injection, blowing, rotational moulding or compression.

8. Application of the structure as claimed in claim 1 to the manufacture of tanks for motor vehicles.

9. Application of the structure as claimed in claim 1 to the manufacture of fuel lines for motor vehicles.
